(19) United States
(12) Patent Application Publication
(10) Pub. No.: US 2002/0134483 A1
(43) Pub. Date: Sep. 26, 2002

(54) Tire breaker for vehicle tire

(76) Inventor: Shut Chen Hsu, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/947,399

(22) Filed: Sep. 7, 2001

Related U.S. Application Data
(63) Continuation-in-part of application No. 09/813,850, filed on Mar. 22, 2001.

(51) Int. Cl. B60C 5/02

(52) U.S. Cl. 152/531; 152/510; 152/521

(57) ABSTRACT

A tire breaker having and an annular body fitting over the periphery of the inner tube of a vehicle tire and adapted to protect the inner tube of the vehicle tire against piercing of external sharp objects, the annular body having a corrugated outside wall and series of through holes through the corrugated outside wall, the corrugated outside wall having plurality of outer portions and a plurality of inner portions alternatively arranged in series, and a plurality of radial intermediate portions respectively connected between the outer portions and the inner portions.

### CROSS-REFERENCE OF RELATED APPLICATION

The present invention is a continuation-in-part of U.S. patent application Ser. No. 09/813,850 filed Mar. 22, 2001.

### BACKGROUND OF THE INVENTION

The present invention relates to vehicle tires and, more specifically, to a tire breaker for vehicle tire, which protects the tire against piercing of external sharp objects.

A motor vehicle is an important transportation device to many people in every city in the world. A fatal accident may occur if one tire of the vehicle explodes during driving. For a safety driving, the condition of the tires of the motor vehicle must be regularly checked. However, regular vehicle tires cannot effectively protect against piercing of an external sharp object. When a nail or the like pierced through the tire of a running motor vehicle, a tire explosion may occur.

### SUMMARY OF THE INVENTION

The present invention has been accomplished to provide a tire breaker for vehicle tire, which protects the tire against piercing of an external sharp object. It is another object of the present invention to provide a tire breaker for vehicle tire, which fits different sizes of tires. It is still another object of the present invention to provide a tire breaker for vehicle tire, which is easy to install. According to one embodiment of the present invention, the tire breaker has an annular shape fitting over the periphery of the inner tube of a vehicle tire and adapted to protect the inner tube of the vehicle tire against piercing of external sharp objects, a corrugated outside wall, and series of through holes through the corrugated outside wall. The corrugated outside wall having plurality of outer portions and a plurality of inner portions alternatively arranged in series, and a plurality of radial intermediate portions respectively connected between the outer portions and the inner portions. According to another embodiment of the present invention, a flexible covering is provided and covered on the body of the tire breaker.

### BRIEF DESCRIPTION OF THE DRAWINGS

FIG. 1 illustrates a tire breaker for vehicle tire constructed according to the present invention.

FIG. 2(a) is a front view of the tire breaker according to the present invention.

FIG. 2(b) is a sectional view taken along line A-A of FIG. 2(a).

FIG. 3 is a sectional view showing the tire breaker installed in the vehicle tire according to the present invention.

FIG. 4 is a plain view showing the tire breaker installed in the vehicle tire according to the present invention.

### DETAILED DESCRIPTION OF THE PREFERRED EMBODIMENT

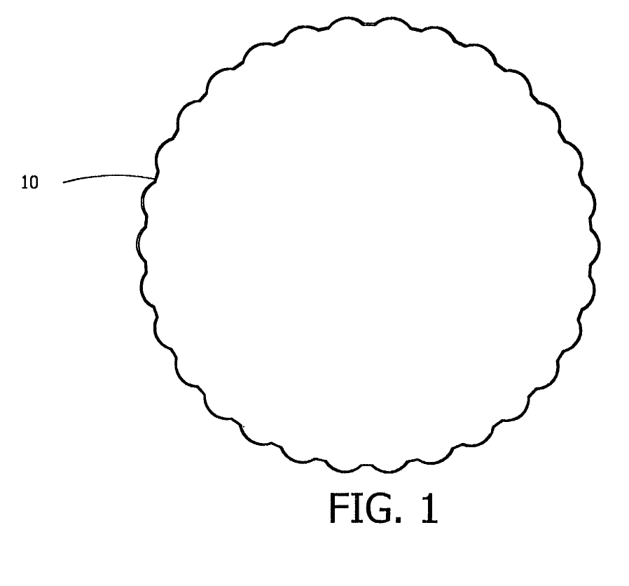

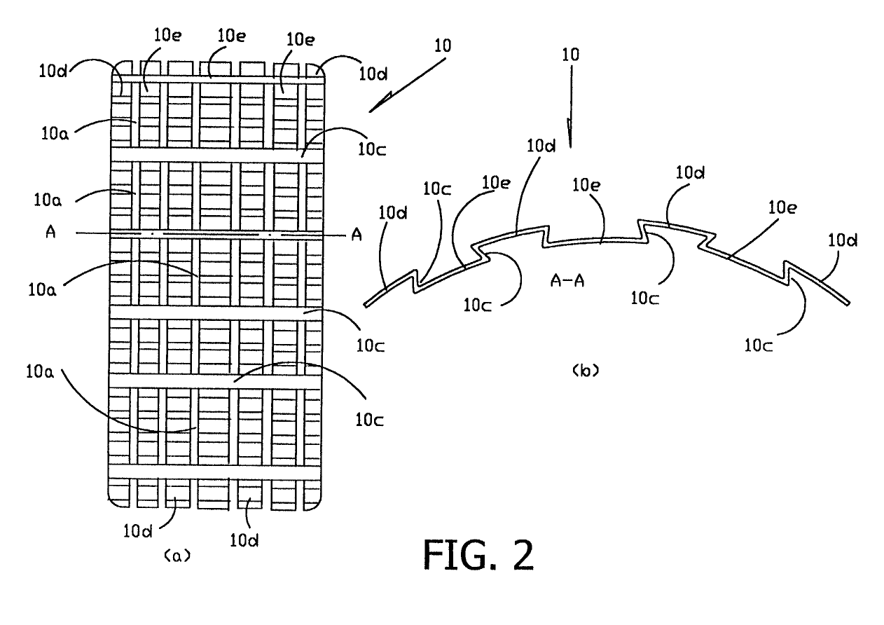

Referring to FIGS. 1, 2a and 2b, the tire breaker, referenced by 10, is made of flexible material and adapted to protect the inner tube of a vehicle tire against piercing of external sharp objects. The tire breaker 10 has an annular shape fitting the periphery of the inner tube of any of a variety of vehicle tires, and a corrugated outside wall. The tire breaker 10 comprises multiple series of through holes 10a arranged in parallel around the periphery. The corrugated outside wall of the tire breaker 10 comprises a plurality of outer portions 10d and a plurality of inner portions 10e alternatively arranged in series, and a plurality of radial intermediate portions 10c respectively connected between the outer portions 10d and the inner portions 10e. Because the outer portions 10d and the inner portions 10e are disposed at different elevations, the corrugated tire breaker 10 is compressible.

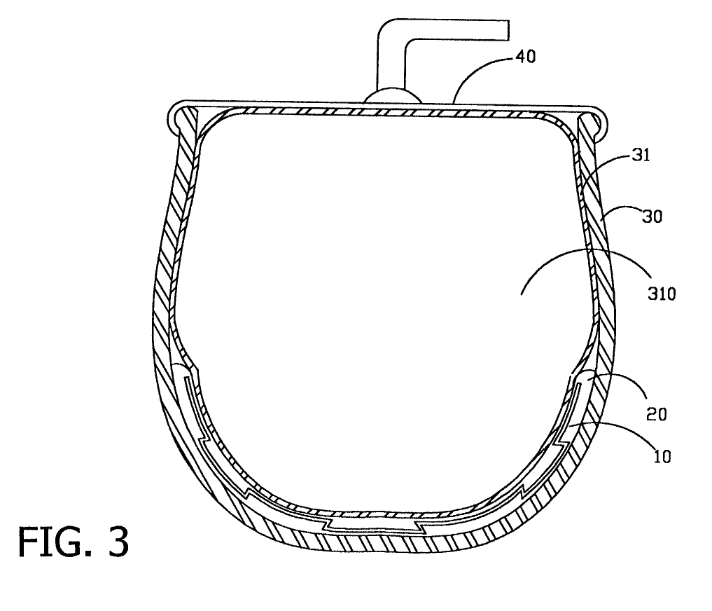

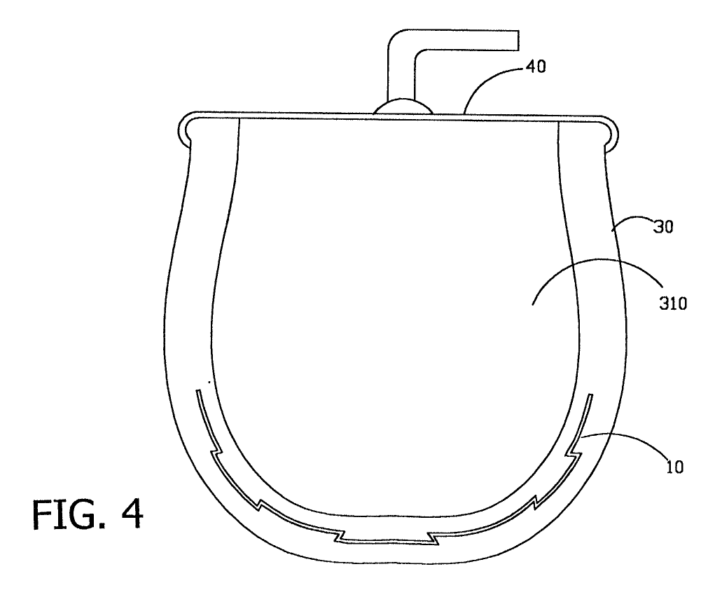

Referring to FIGS. 3 and 4, the tire breaker 10 is covered with a flexible covering 20, and then put around the inner tube 31 in the outer tire 30, which is fastened to the rim 40 of the vehicle tire. After installation, the inside space 310 of the inner tube 31 is filled up with air. After the inner tube 31 has been inflated, the flexible covering 20 and its inside tire breaker 10 are squeezed in between the outside wall of the inner tube 31 and the inside wall of the outer tire 30 to protect the inner tube 31 against piercing of external sharp objects.

A prototype of tire breaker for vehicle tire has been constructed with the features of the annexed drawings of FIGS. 1˜4. The tire breaker for vehicle tire functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A tire breaker having an annular body fitting over the periphery of the inner tube of a vehicle tire and adapted to protect the inner tube of the vehicle tire against piercing of external sharp objects, said annular body comprising a corrugated outside wall, and multiple series of through holes arranged in parallel around the periphery thereof, said corrugated outside wall comprising a plurality of outer portions and a plurality of inner portions alternatively arranged in series, and a plurality of radial intermediate portions respectively connected between said outer portions and said inner portions.

2. The tire breaker of claim 1 further comprising a flexible covering covered on said annular body to hold said annular body in between the inner tube and outer tire of the vehicle tire.

3. The tire breaker of claim 1 wherein said annular body is embedded into the outer tire of the vehicle tire.
